(19) United States
(12) Patent Application Publication
(10) Pub. No.: US 2023/0011815 A1
(43) Pub. Date: Jan. 12, 2023

(54) Nuclear Fusion Apparatus And Method

(71) Applicant: Dan Bar Zohar, Holon (IL)

(72) Inventor: Dan Bar Zohar, Holon (IL)

(21) Appl. No.: 17/779,966

(22) PCT Filed: Nov. 9, 2020
(86) PCT No.: PCT/IL2020/051163

§ 371 Date: May 25, 2022

(30) Foreign Application Priority Data
Dec. 2, 2019 (IL) 271106

(51) Int. Cl. G21B 3/00

(52) U.S. Cl. CPC G21B 3/008

(57) ABSTRACT

A nuclear fusion apparatus comprising a tank filled with deuterium and tritium gas mixture, a fast rotating turbine that rotates inside the tank, and a motor to drive the said turbine. The turbine tip moves at a speed larger than the speed of sound of the gas to create shockwaves in the gas. The shockwaves emanate from the turbine tip. The shockwaves are then further compressed by cone-like shaped recessed members or wedge like grooves located near the turbine. The high heat and pressure created by compression of the shockwave create fusion reaction of the gas nuclei. Due to the fast rotation of the turbine and the large number of cone-like shaped members, thousands of small fusion events are created each second. Components are provided to induce resonance in the gas that increase the heat and pressure off the shockwaves.

### FIELD OF THE INVENTION

The present invention relates to the field of fusion reactors and more particularly relates to an apparatus for fusing nuclei of hydrogen isotopes to produce energy.

### BACKGROUND OF THE INVENTION

Fusion energy can fulfill the energy needs of mankind without the complications of fission energy or hydrocarbon fuels. Great effort and resources were invested to achieve this goal, however, the very high temperature required to reach fusion was found to be an obstacle that the technology could not answer. Since the 1950s many experiments were conducted to fuse hydrogen isotopes deuterium and tritium, and large sums of money were invested.

As of this time, a device that yields a positive energy surplus from fusion reaction has not been found, though, there is a progress in temperatures, confinement time and pressure of the latest devices.

The progress toward fusion is focused in two directions: one is inertial confinement and the second is magnetic confinement.

Much of the fusion reaction research is done on magnetic confinements devices. In magnetic confinement a plasma is heated in a donut shaped magnetic bottle. The hot plasma is heated inside the magnetic bottle without contacting walls of the device. Insulating the hot plasma from the device walls prevents cooling of the plasma from the walls, and protects the walls from melting or burning. The tokamak is the main device that uses this technique. Dozens of such devices have been built since the 1950s in many countries. As time progressed their size grew bigger to achieve higher temperatures. The main problem of the tokamak is plasma instabilities and turbulence that causes the plasma to cool, and the walls to evaporate and contaminate the plasma. The latest tokamak to be built is the ITER in France that is built with cooperation of many countries and cost around 20 billion dollars. It will be finished in 2025, and its designers claim that it will have energy output ten times that of the input energy.

Inertial confinement is produced by focusing many high energy lasers into a deuterium and tritium filled spherical capsule. The main device that uses this method is the National Ignition Facility (NIF) at Lawrence Livermore Lab in California US. This device is using a hohlraum, which is a small tube, and a d-t capsule placed at its center. When the lasers hit the inner wall of the hohlraum, a burst of X-rays is produced that heat the outer envelope of the hydrogen capsule. This causes the envelope to explode and produce a powerful shockwave toward the spherical capsule. The shockwave causes the hydrogen in the capsule to compress; its compressed radius is ⅟13 of its original radius.

The Inertial confinement method has some resemblance to the present invention. The present invention also uses shockwaves to compress and heat a small amount of deuterium and tritium. Inertial confinement by lasers have some downsides compared to the present invention. Each firing of the lasers is destructive and destroys the surrounding of the hohlraum, therefore, there is a limit to the frequency of the firing events and to the power output of the device. Currently the NIF device can fire about one time per day. The current invention on the other hand produces shockwaves on a continuous basis by a turbine. The frequency of the events can reach several thousand a second, and with the low magnitude of each event, they are not as nearly destructive as the events in the NIF device.

Fusion devices can also use electrical sparks, explosions, and release of high pressure gas by valve or diaphragm to produce shockwaves as depicted for instance in U.S Pat. 4367130 and 4182650.

The z-machine at New Mexico US uses a large capacitor bank that is discharged with a current of 26 million amperes to implode a d-t capsule.

Other experiments use high speed projectile that hit a d-t capsule. Such a device is shown in U.S Pat. 4435354.

General Fusion is a company researching a fusion device based on pneumatic hammers that hit a plasma to compress and heat it.

There is also the field of sonoluminescence that uses the cavity implosion phenomenon to compress a d-t bubble to produce fusion.

In the 1950s US conducted the Sherwood program, and one branch of research within this program conducted experiments which compress d-t plasma with shockwaves. The shockwaves were produced by strong magnetic fields generated by a pulse of electric current passing through electromagnets.

### SUMMARY OF THE INVENTION

The current invention provides a nuclear fusion device. The device uses a fast rotating impeller or turbine inside a deuterium tritium gas tank to produce strong shockwaves. A rim around the turbine provides a plurality of cones like dents. The shockwaves hit the cone like dents and compress further the shockwave into a small point at the cone tip or vertex. At that point the d-t gas reaches a high temperature and pressure to enable fusion reaction.

The said turbine will have, for instance, a diameter of 60 cm and will rotate at a speed greater than 100000 RPM. The tip of the turbine blades at those speeds will be around 3 times the d-t gas speed of sound, speed high enough to produce high energy shockwaves. The turbine rotates, for instance, by a powerful electric motor capable of delivering 500 kilowatt of power or more at high speed. The turbine blade has a flat tip perpendicular to the rotation direction. The flat tip increases the magnitude of the shockwaves, but also increases the gas drag of the turbine that is overcome by the high power motor.

The high speed of the turbine and the large number of cones will create thousands of fusion events per second. Each of the fusion events will be small enough to not destroy the device. Therefore, the device operation can be continuous without interruptions. The device is easy to control - to start the device you switch the electric motor on, and to shut it off you switch the electric motor off. It is also possible to control the energy output of the device by changing the rotation speed of the turbine and motor; the faster the turbine goes the higher the energy output is.

This device is also very compact in size and could be easily fitted to drive a ship. The production costs and maintenance costs of the device will also be very small due to the fact that it is mechanical in nature with three main components: the turbine, the cones rim and an electric motor.

According to the Lawson criterion the effectiveness of a fusion reactor depends on both the confinement time and the density of the d-t gas. In magnetic confinement the density of the gas is very low while the confinement time is large. In a laser inertial confinement device, the density is very large while the confinement time is short. In the present invention there are thousands of events per second so both the confinement time and the gas density are large to comply with the Lawson criterion.

There are three challenges that this device must overcome to work properly.
1. The temperature and pressure of the d-t gas inside the cones will not be high enough. This can be fixed by rotating the turbine faster, increasing the turbine diameter or increasing the blade area. It is also solved by increasing the size of the cones so that more high energy d-t gas will enter from the shockwave.
2. The tip of the cones will evaporate from the high temperature of the gas and that will hinder its ability to compress the shockwaves. One solution is to provide the cones with a replaceable tip that will be replaced during the operation of the device every few minutes by a robotic arm. According to this solution the tip of the cones is provided with a thread, so it has a bolt like shape, and can be easily replaced by rotating the bolt head. Another solution is to use dents with a parabolic shape. When the shockwave will hit this parabolic dent, it will be concentrated to a point far from the metallic surface of the dent. Separating the concentrating point from the metal surface will prevent evaporation of the surface. Moreover, the turbine will produce turbulence inside the gas that will help cooling the cones.
3. The turbine will melt from the high temperature or will break from the centrifugal forces. This is solved by using high temperature alloys similar to those used in jet engines or a titanium that is of lightweight and has a high melting point. The tip of the turbine has a rounded shape that will disperse the friction heat to the surrounding gas and prevent the accumulation of heat on the turbine itself. This is similar to the rounded nose shape of an atmospheric reentry vehicles, like the space shuttle, built to disperse the heat to the air around it.

The turbine, cones rim and electric motor will reside inside a duct comparable in diameter to the cones rim diameter. When fusion is ongoing inside the cones it will produce alpha particles and neutrons. The high energy alpha particles will heat the d-t gas at the cone rim. A gas pump will carry the hot d-t gas from the cone rim toward a boiler or heat exchanger that will absorb the d-t gas heat. This gas pump is also protecting the cone rim and turbine from overheating and melting as it drives cooler gas toward the cone rim. The high energy neutrons will convey their heat to a blanket around the cone rim. This blanket will contain boilers to absorb the heat and cool the blanket. The boilers will produce steam to drive a turbogenerator. The said blanket will also contain lithium. The impact of the high energy neutrons in lithium will produce tritium which is one component of the fuel necessary to operate a fusion reactor.

### BRIEF DESCRIPTION OF THE DRAWINGS

FIG. 1 is a schematic cross-sectional front view of the cone rim and the turbine.

FIG. 2 is a schematic cross-sectional side view of the cone rim, and a side view of the turbine and the motor. The turbine rotates inside the cone rim, but in this drawing they are shown separated for clarity.

FIG. 3 is a schematic cross-sectional view of a cone-like shaped dent, used to compress the shockwave, where the tip of the cone resides in a bolt to be replaceable.

FIG. 4 is a schematic inner view of a segment of the cone rim showing the arrangement of the cones, the cone inlet and their tip.

FIG. 5 is a schematic cross-sectional side view of an alternative embodiment of the rim where wedge-like grooves are provided along the inner circumference of the rim to compress the shock waves.

FIG. 6 is a schematic cross-sectional view of a cone-like shaped dent, used to compress the shockwave.

FIG. 7 is a schematic cross-sectional view of a cone-like shaped dent, used to compress the shockwave, where the cone is tilted toward the rotation direction of the turbine.

FIG. 8 is a schematic cross-sectional view of a cone-like shaped dent, used to compress the shockwave, where the walls of the cone are convex.

FIG. 9 is a schematic cross-sectional view of a cone-like shaped dent, used to compress the shockwave, where the walls of the cone are concave.

FIG. 10 is a schematic cross-sectional view of a parabolic contoured dent, used to compress the shockwave to a focal point far from the dent wall.

FIG. 11 is a schematic cross-sectional view of a cone-like shaped dent, used to compress the shockwave, where the tip of the cone has a parabolic contour.

FIG. 12 is a schematic cross-sectional view of a cone-like shaped dent, used to compress the shockwave, where the vertex section of the cone is removed to provide a shockwave focal point outside of the cone.

FIG. 13 is a schematic front view of one blade of the turbine having a rectangular shape.

FIG. 14 is a schematic front view of one blade of the turbine having a circular shape.

FIG. 15 is a schematic cross-sectional side view of one blade of the turbine showing the rounded edges of the blade.

FIG. 16 is a schematic cross-sectional side view of one blade of the turbine having a Hemispherical shape.

FIG. 17 is a schematic cross-sectional side view of one blade of the turbine having a spherical shape.

FIG. 18 is a schematic cross-sectional side view of one blade of the turbine where the blade is curved backward to create a shockwave that fits the curvature of the cone rim.

FIG. 19 is a schematic cross-sectional side view of one blade of the turbine where the blade is curved forward.

FIG. 20 is a schematic cross-sectional side view of one blade of the turbine where the blade is tilted forward.

FIG. 21 is a schematic front view of the turbine having a propeller shape.

FIG. 22 is a schematic side view of the turbine having a propeller shape.

FIG. 23 is a schematic cross-sectional view of the cone rim and blade further provided with circular walls to enable resonance of the shockwave.

FIG. 24 is a schematic cross-sectional view of the cone rim and blade further provided with rectangular walls to enable resonance of the shockwave.

FIG. 25 is a schematic cross-sectional view of the cone rim and blade further provided with triangular walls to enable resonance of the shockwave.

FIG. 26 shows an arrangement to prevent fast burn of the cones. The cones are on six rims - having the cones at the outer side of the rim - that rotates to substitute the cones facing the turbine at the center. The upper rim is shown fully, whereas only segments of the other five rims are shown.

FIG. 27 is a side view of the apparatus of FIG. 25 showing only two cone rims out of six and the turbine at the center.

FIG. 28 is a schematic view of the fusion powerplant having the turbine and the cone rim at its center, and showing the blanket and boilers.

### DETAILED DESCRIPTION OF THE INVENTION

The invention’s main concept is to use a fast rotating turbine to produce shockwaves. The turbine rotates in a tank filled with a mixture of deuterium and tritium gas. The turbine speed in the gas is much faster than the speed of sound of the gas so it constantly produces shockwaves in the tank. The tank walls contain cone shaped dents that further concentrate the shockwaves at the vertex or tip of the cones to create fusion events.

A fast rotating and powerful motor drives the turbine at very high speed to produce high energy shockwaves.

The strength of the shockwaves and the energy extracted from fusion are controlled by the speed of the motor―turning the motor faster will increase the strength of the shockwaves and the amount of energy produced. The motor can drive the turbine for unlimited time to provide continuous energy production.

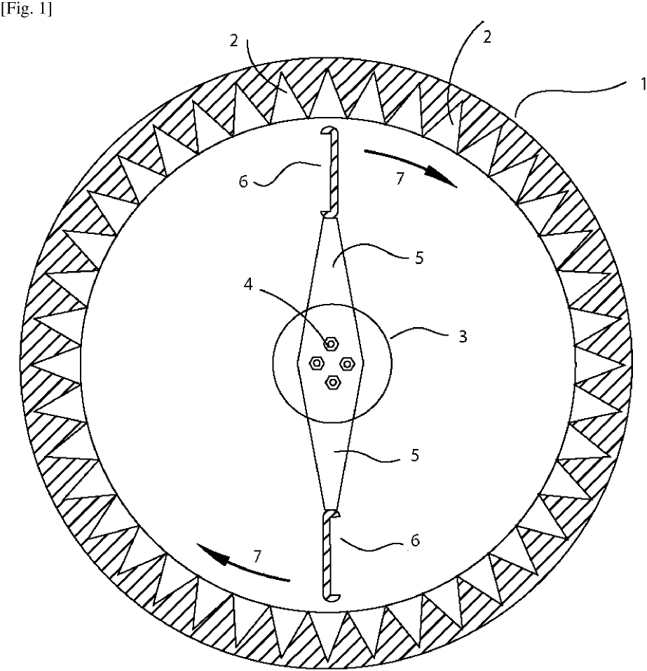

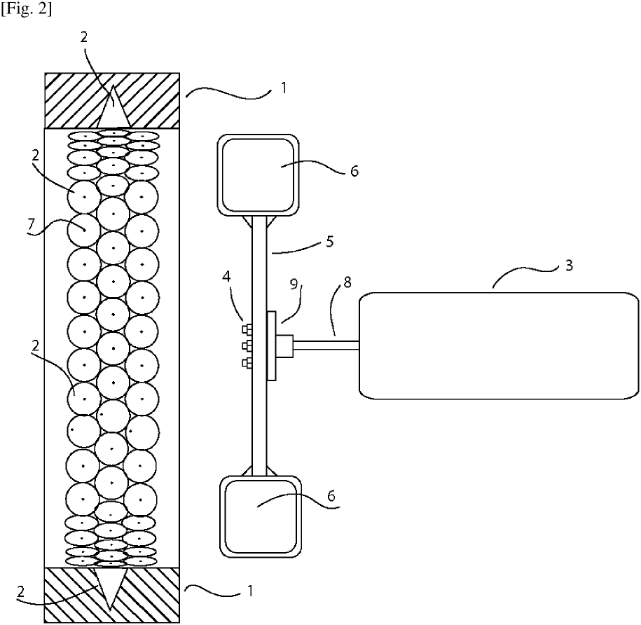

FIG. 1 shows a front view, and FIG. 2 shows a side view of a preferred embodiment of the invention. A ring or rim 1 is covered with cone shaped recesses 2 at its inner side. The cone recesses are bored into the rim from its inner side. The rim is thick enough, so that the cone tip is embedded within the rim and far from the outer side of the rim. FIG. 2 shows the cross sectional side view of the rim 1. The cones 2 are embedded in the inner side of the rim, and arranged in interlocked lines, for maximum density, to utilize efficiently the shockwave energy. The inner walls of the cones are precisely circular, and highly polished in order to not disperse the incoming shockwaves, and effectively compress the shockwave at the cone tip 7.

A fast-rotating turbine resides inside the rim 1. The turbine is composed from a flat surface 6 and an arm 5 connecting the flat surface 6 to the electric motor 3 shaft 8 through bracket 9. When the turbine rotates this flat surface 6 moves forward and its surface is perpendicular to its forward movement. The flat surface when fast moving through the gas has a large drag to create powerful shockwaves.

The arm 5 have to withstand high tensile forces from the fast rotation centrifugal forces. The tensile force is higher near the rotation axis then at the arm tip near the flat surface 5. To better withstand the tensile forces the arm near the rotation axis 4 is wider than near the flat surface 6. The exact shape of the arm can be optimized with a computer software.

Dimensions of the device can be provided by way of an example only. For instance, the turbine diameter is 60 centimeters. The flat surface has a square shape with a side length of 5 centimeters. The distance between the tips of the turbine to the inner side of the cone rim is 8 centimeters. Large distance between the turbine tip and the inner side of the cone rim ensures that the shockwaves front will be parallel to the cone base. If the shockwave front is parallel to the cone base, the compression of the shockwave will be uniform along the cone and will not form instabilities. The diameter of the inner side of the cone rim is therefore 76 centimeters. The circular cone base has a diameter of 5 centimeters. The angle between the cone axis and its side wall is 20 degrees so the cone tip angle is 40 degrees. The cone height is 6.85 centimeters, and the cone rim width is 9 centimeters.

The turbine material has to withstand high tensile forces from the fast rotation centrifugal forces. At the same time, it has to withstand high temperature from the gas friction, and the fusion reaction at the cones. Alloys like Chromium Molybdenum steel or nickel iron chromium alloy can provide both the high temperature resistance and the high strength required. Titanium can also be used as it is lightweight and will not produce large centrifugal forces. It is also strong and can withstand high temperature with a melting point of 1668° C.

The turbine can also be coated with high temperature material like tungsten or ceramics.

The turbine has to work in conditions very similar to that of a jet engine blades and therefore can use the same alloys. Jet engines blades are equipped with micro channels for cooling. Those micro channels can also be combined in the turbine for cooling.

The cone rim is not subjected to tensile force so its main requirement is to withstand high temperature and evaporation. The cone rim is therefore made of the same turbine materials or of heavier alloys like tungsten steel. The cone rim is also water cooled. Metal tubes are embedded in the cone rim and water is pumped through them to cool the cone rim.

The tip of the turbine rotates much faster than the gas speed of sound. The speed of sound of hydrogen gas is 1294 meters per second. If the tip off the turbine moves 3 times the speed of sound in the gas and the turbine diameter is 60 centimeters, then the rotation speed of the turbine is 123630 rounds per minute.

To decrease the speed of sound of the gas, other atoms of heavier elements could be mixed with the deuterium and tritium gas. The deuterium and tritium could form molecules with the heavier elements, or the heavier elements could form molecules that do not contain deuterium or tritium. For instance, the deuterium and tritium could be combined with oxygen to form D20 and T20, and reside in the turbine tank as vapor or steam. The heavier elements will increase the mass of the gas - by that they will decrease the speed of sound, and will enable shockwaves of higher mass and energy. The heavier atom can be used as “hammers” - when two deuterium and tritium atoms will be positioned exactly between two heavier atoms, they will press the deuterium and tritium atoms to fuse. Decreasing the speed of sound of the gas will enable to rotate the turbine at lower speed.

Further method to decrease the speed of sound is to increase the pressure of the deuterium and tritium gas inside the turbine tank. Increasing the gas pressure will increase the gas density and will increase the mass and energy of the shockwaves.

Electric motor 3 is preferred for driving the turbine. Electric motor can rotate at high speed, so its shaft can be attached directly to the turbine, and doesn’t require a gear box or chain to increase the rotation speed. The motor has to provide considerable power to drive the turbine at high speed and overcome the gas drag. The turbine is not built with an aerodynamic shape, on the contrary, it is built to maximize the drag in order to create turbulence and shockwaves. The motor can be an induction motor, or be a permanent magnet motor where the rotor of the motor is made from permanent magnets like alnico or neodymium. The stator applies a rotating magnetic field on the rotor. The stator includes several electromagnets winded with copper coils. A microcontroller can control the flow of electric current in the coils to create the rotating magnetic field and determine the rotor speed. Optical encoder on the rotor provides feedback for the microcontroller.

The motor rotation speed is very high. To easily balance the rotor and to prevent vibration, the rotor diameter has to be small, for instance, 6 or 7 centimeters. The motor also has to supply high power ranging at around 500 kilowatt or more. To provide this power despite the small rotor diameter the motor has to be very long up to several meters in length.

The operation of the motor will dissipate heat. The motor will also operate in a hot gas of several hundred degrees. To protect the motor from excess heat, it has to be water cooled and enveloped with thermal insulation.

A magnetic field is applied to the cone rim. The direction of the magnetic field is parallel to the cone’s axis. The magnetic field helps to prevent instabilities, and by that enable to reach higher pressure and temperature at the cone tip.

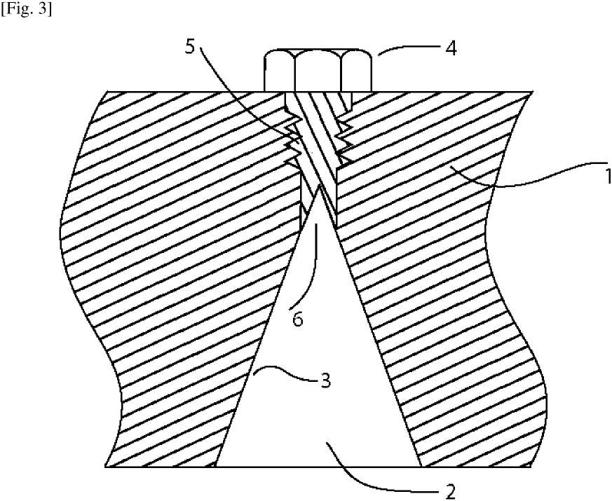

The tip of the cones in FIG. 1 are in contact with high temperature and pressure from the shockwave that will cause evaporation of the metal at this point. This evaporation will change the shape of the cone tip, it will prevent it from functioning properly to compress the shockwave, and will stop the operation of the device. To overcome this problem a replaceable cone tip is provided that will be changed every few minutes during the operation of the device. In FIG. 3 the tip of the cone 6 is at the end of a bolt 4 that can be easily replaced. The bolt 4 is screwed from the outer side of the cone rim 1 using a thread 5, and when it is locked into position it complements the shape of the cone 3 and comprises its tip. The bolt can be replaced very fast, in less than a second, and can withstand the high pressure from the shockwave. A robotic arm is used to replace the bolts along the circumference of the rim during the operation of the device, to enable the device to work continuously and without any interruptions. The walls of the cones 3 have to be very smooth and accurate to provide a symmetrical compression of the shockwaves.

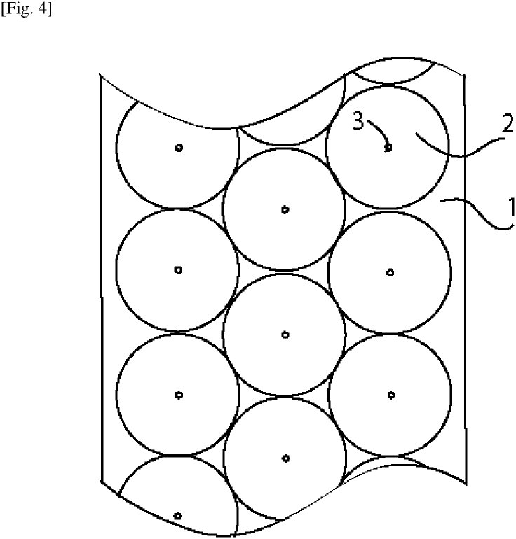

FIG. 4 shows part of the inner side of the cone rim 1. The cone base is faced toward the turbine so shockwaves from the turbine enter the cone to be compressed at the cone tip 3. The cones 2 are placed tightly together and arranged in lapping lines to utilize efficiently the shockwaves energy. It is possible to use a hexagon base for the cones so that more energy can be absorbed from the shockwave. The cones will have a hexagon base, and as it progresses toward the tip the profile will gradually transform into a circular shape.

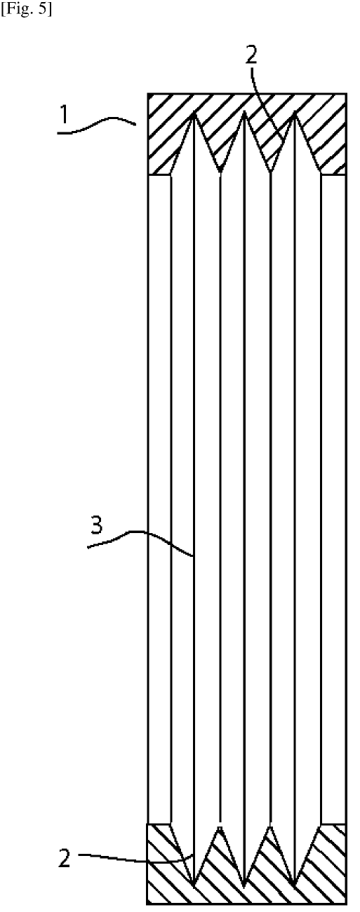

FIG. 5 shows an alternative embodiment of the cone rim. Instead of the cones this embodiment uses a wedge like grooves 2 along the inner circumference of the rim 1. The shockwaves enter the wide side of the wedge to be compressed at the wedge vertex or tip 3. In the cone rim of FIG. 1 the shockwave focal point is always at the same place - at the tip of the cone. With the wedge like grooves, the focal point is not stationary and can travel along the wedge tip line. Therefore, the wedge like grooves are less likely to burn and evaporate, and can provide a longer operation life than the cones. Also, the wedge like shape is more exposed and can be cooled more effectively than the cones.

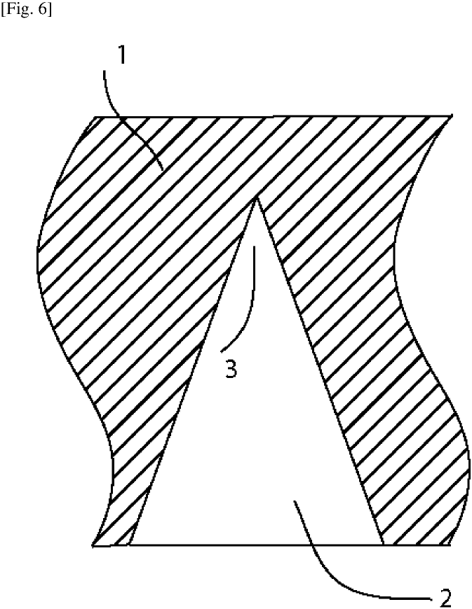

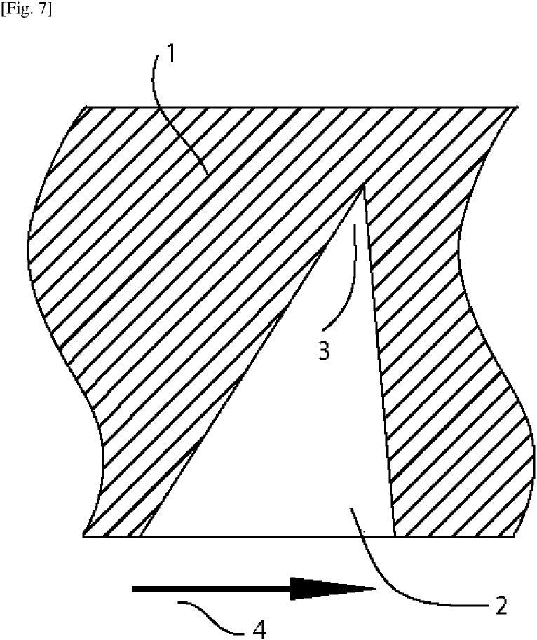

The fast rotation of the turbine will produce shockwaves emanating from the flat surface of the turbine. Due to the rotation of the turbine the shockwave front doesn’t travel straight outward but inclines forward to the rotation direction. To create perfectly symmetrical compression in the cones, their axes have to be exactly parallel to the shockwave travel direction. Therefore, the cones have to be inclined forward as shown in FIG. 7. The cone rim is denoted 1, the cone is denoted 2 and the cone tip is 3. The turbine rotation direction is denoted by an arrow 4. Further modification can provide the cone base, or entrance, to be perpendicular to the inclined cone axis. This way the cone base will be parallel to the shockwave front to provide symmetrical compression. In comparison, FIG. 6 shows a straight cone that its axis has a radial direction.

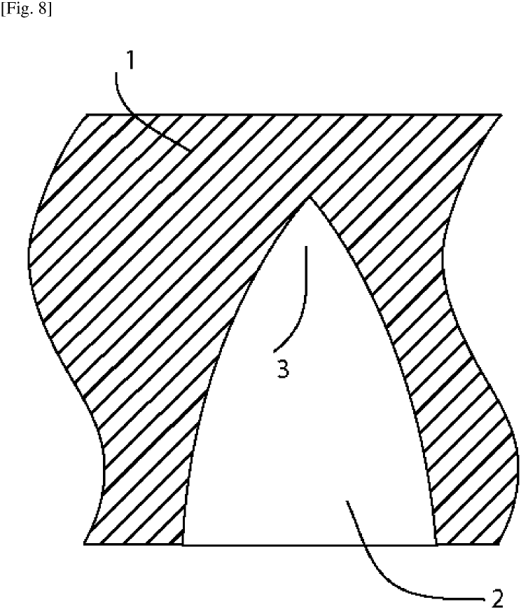

In FIG. 8 the cones walls 2 are convex. This outline can decrease the friction between the shockwave and the cone walls to reduce the shockwave energy lost to friction. This outline will also enable faster cooling of the tip 3 to prevent its evaporation.

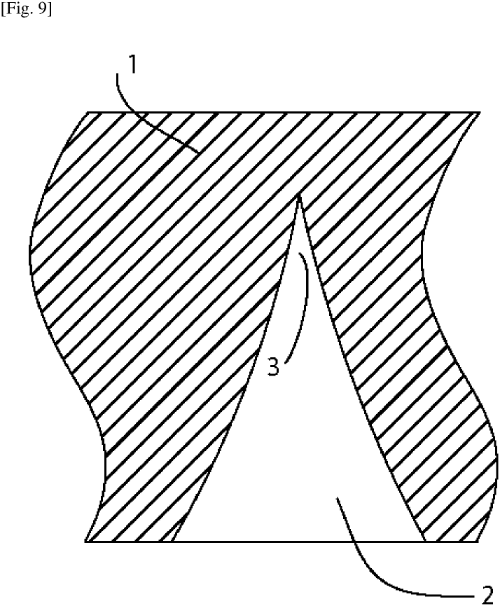

In FIG. 9 the cone walls 2 are concave. This arrangement provides the cone with narrower tip 3 that will compress the gas to a smaller volume to reach higher temperatures.

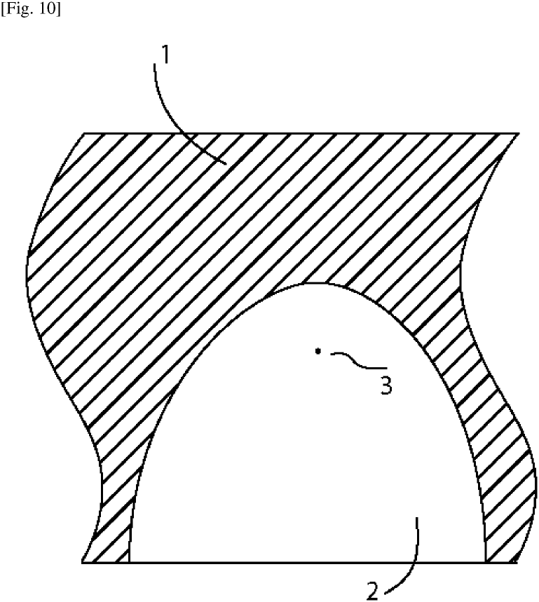

In FIG. 3 the shockwave is compressed to the cone tip 6. At the tip 6 the compressed gas reaches its highest temperature and pressure. The metal at the tip is in contact with the hot plasma and it will melt and evaporate. This will deform the tip to consequently prevent proper compression of the gas and will stop the operation of the device. It is therefore necessary to separate the hottest point of the plasma from direct contact with the metal surface. It is well known, from the field of optics, that light can be concentrated into a focal point using a reflective parabolic surface. This can be found, for instance, in flashlights or car headlights. Similarly, the shockwave front can be concentrated into a focal point using a parabolic surface. The shockwave will hit the parabolic surface and many molecules from the gas shockwave will bounce back from the parabolic surface into a focal point. At this focal point the gas will turn into plasma at high temperature and pressure. This focal point will be far from the metal surface, as intended, so it will not damage it as in the case of direct contact. FIG. 10 shows a rim 1 filled with parabolic holes or dents 2. The parabolic holes have a focal point 3, where the shockwave will be concentrated and turn into plasma.

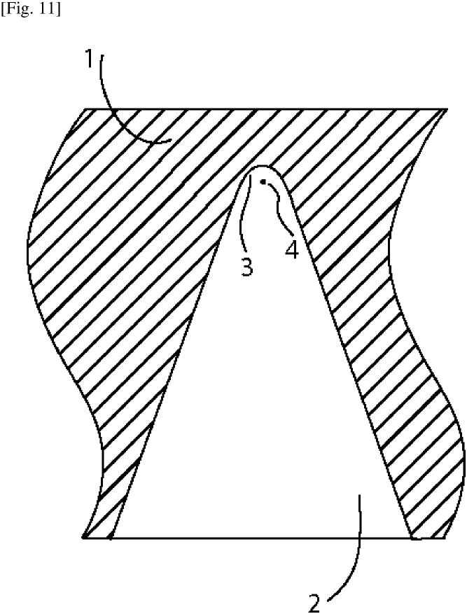

In FIG. 11 a cone 2 is combined with a parabolic tip 3 to reflect the shockwave into a focal point 4 far from the metal surface of the tip. Compared to the parabolic surface of FIG. 10, the cone tip parabolic surface is smaller, and therefore will have a better chance of aiming the molecules of the shockwave into the focal point. The shockwave will be concentrated first by the cone walls and later, near the tip, by the parabolic surface.

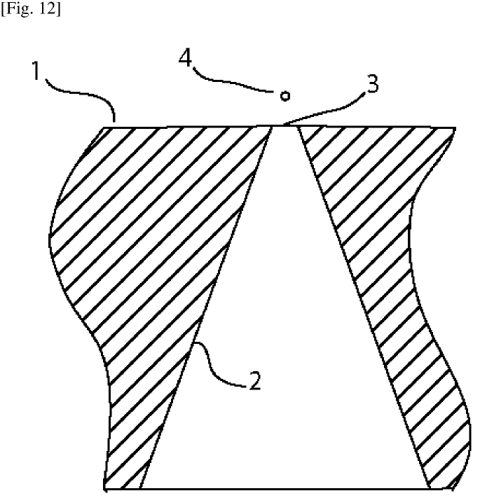

FIG. 12 shows a further arrangement that separates the metal surface from the shockwave focal point. According to this arrangement, the cone tip is missing and instead there is a truncated tip or opening 3. As the shockwave travels along the truncated cone 2, it is compressed by the cone, and the molecules of the shockwave receive a linear direction defined by the cone walls. The molecules follow this linear direction, and as they exit the cone through the opening 3, they arrive at the focal point 4 outside the cone. This focal point is where the cone tip should have been if the cone was not being truncated.

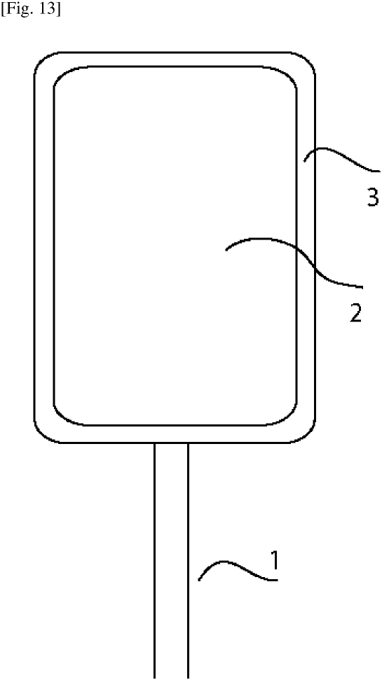

One embodiment of the turbine blade is shown in FIG. 13. The blade has a flat surface 2 directed perpendicular to the movement of the blade in the D-T gas. The flat surface of the blade creates large resistance and drag as it hits the gas to create strong shockwaves and turbulence in the gas. The blade has a rectangular shape where the corners of the rectangle are rounded. The edges 3 of the rectangle have a circular cross section. The turbine rotates very fast so the friction with the gas heats the blade, and there is a risk of the blade melting. The circular edged 3 helps to minimize the accumulation of heat in the turbine and to dissipate that heat to the nearby gas. The solution of rounded surface is used for instance in space reentry vehicles like the space shuttle that enter the atmosphere from outer space. The space shuttle rounded nose helps to dissipate the friction heat to the surrounding gas. The rule here is to avoid sharp corners as these are likely to be melted by the heat. A rod 1 is connecting the blade flat surface to the blade rotation axis. The turbine is made from high temperature alloy with high tensile strength to withstand the centrifugal forces.

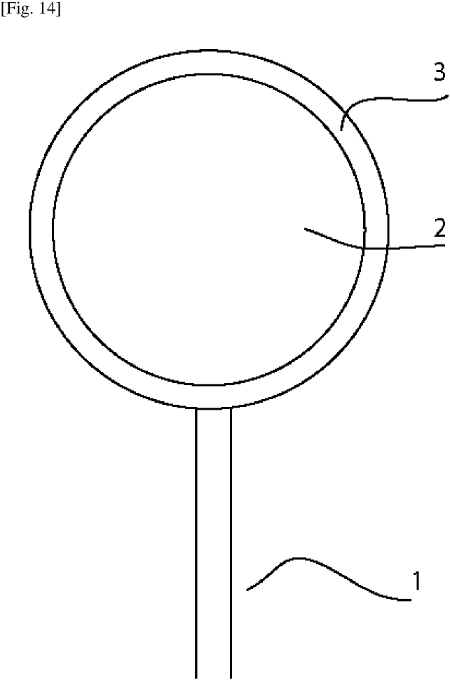

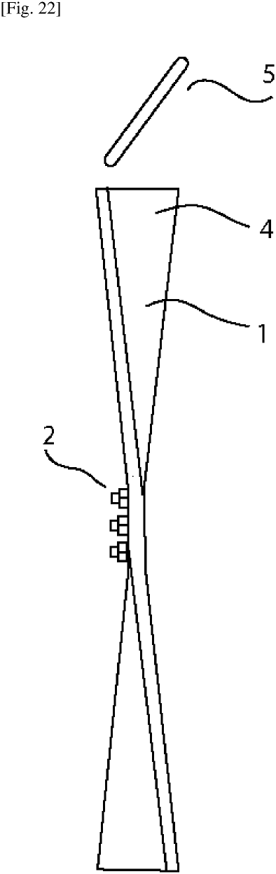

FIG. 14 shows a further embodiment of the blade where the flat surface 2 is circular. The edges 3 are rounded to increase the heat resistance of the blade. A rod 1 is connecting the circular flat surface to the blade rotation axis. The circular flat surface will produce shockwaves evenly in all directions, and are especially useful to produce resonance of the gas shockwaves. Resonance can be used to increase the shockwave energy, pressure and temperature. To produce resonance the blade flat surface can move in a channel or conduit. The gas shockwave will bounce from the conduit walls to be combined and amplified by a new shockwave from the blade. To produce shockwaves that propagate in all directions to hit the walls of the conduit the circular flat surface of FIG. 14 is most suitable. Configurations that use conduits and circular flat surface to achieve resonance are depicted in FIGS. 22, 23, 24.

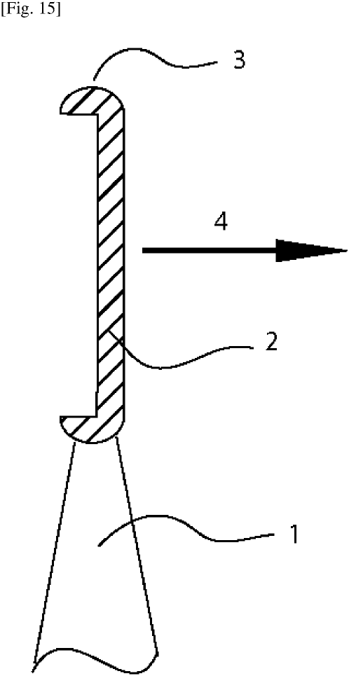

FIG. 15 shows a cross section of the blade. A rod 1 carries the blade flat surface 2 that is perpendicular to the blade movement direction 4. The rectangular flat surface has rounded edges 3.

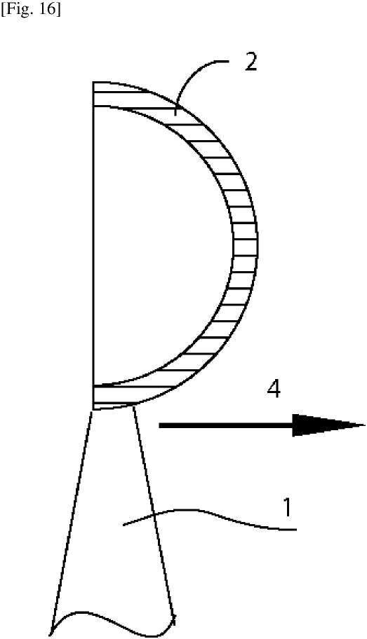

To further increase the heat resistance of the turbine blades a semi-spherical blade is used. FIG. 16 shows a cross sectional side view of a hemispherical blade. A rod 1 connects the semi-sphere 2 to the rotation axis. The rotation direction is denoted by arrow 4. The semi- spherical configuration will produce small shockwaves in front of the blade, where the round part of the hemisphere is, and stronger shockwaves at the rear end of the blade where the flat part of the hemisphere is. The Hemispherical shape is hollow to decrease its weight. Lower weight will decrease the centrifugal forces it produces and enable to easily balance the turbine.

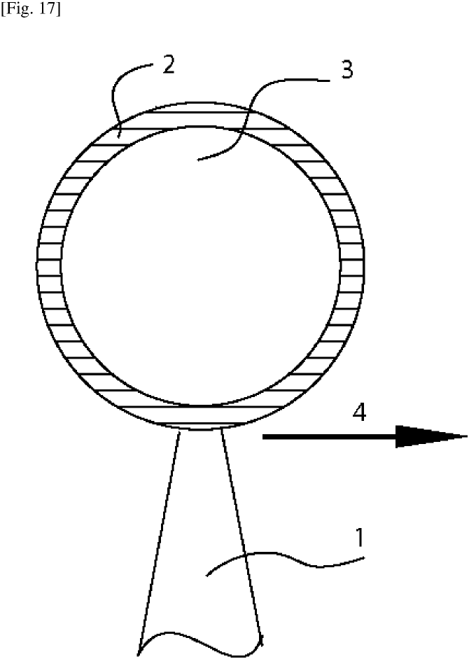

A full spherical configuration is shown in FIG. 17. A rod 1 is connected to a sphere 2. The sphere is hollow inside 3 to lower its weight. The rotation direction is shown by an arrow 4.

Both the spherical and hemispherical blades are suitable to a resonance configuration.

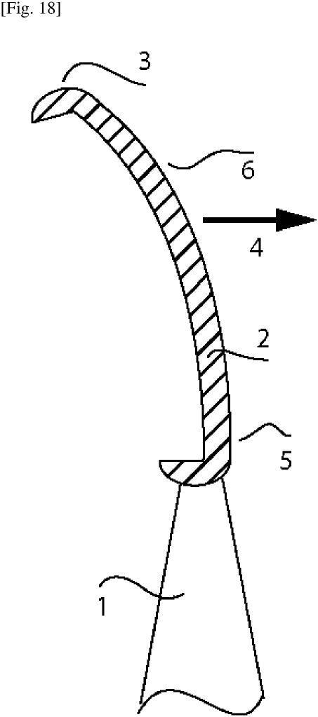

When a shockwave enters the cones, its front has to be parallel to the cone base. Since the cone rim (Denoted 1 in FIG. 1) has a circular shape, it is preferred that the shockwave will also have a circular front to have a match between them. This match will enable the shockwave to enter the cones roughly parallel to their base. To produce a curved front shockwave the turbine surface is curved backwards as shown in FIG. 18. The shockwave is always parallel to the surface that creates it, so a curved surface will produce a curved shockwave that will fit the circular shape of the cone rim. In FIG. 18 the curved surface is denoted 6 and it rotates in a direction denoted by the arrow 4.

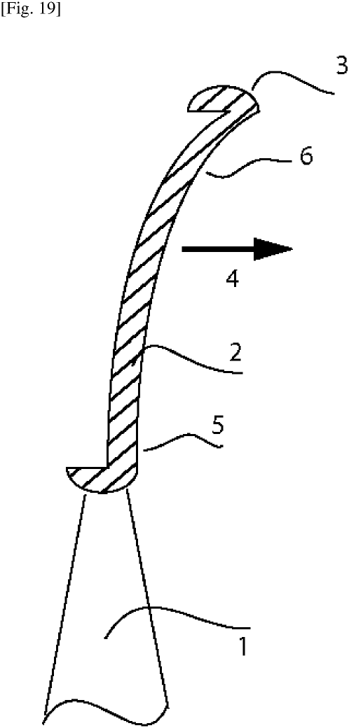

In FIG. 19 the surface 2 that creates the shockwaves is not flat but is curved forward. This feature can be found in centrifugal pumps. The forward curve in the blade of a centrifugal pump increases the flow speed but reduces the pressure. In FIG. 19 the blade moves forward as denoted by arrow 4. A centrifugal force is exerted on the gas at the bottom of the blade 5 that accelerates it upward. When the gas reaches the curved surface 6 it is accelerated forward. This increases the shockwave speed and energy. The blade forward curve also increases the shockwave forward direction so the cones have to be slanted forward as seen in FIG. 7.

The tank that the turbine rotates inside is filled with deuterium and tritium gas mixture. Tritium has a half-life of 12 years, so it is not found in nature, but has to be created by breeding. This makes tritium gas very expensive. Lowering the gas pressure inside the tank can therefore decrease the operation costs of the device. The forward curve of the blades increases the shockwave speed and energy and thereby enable the device to operate at lower gas pressure.

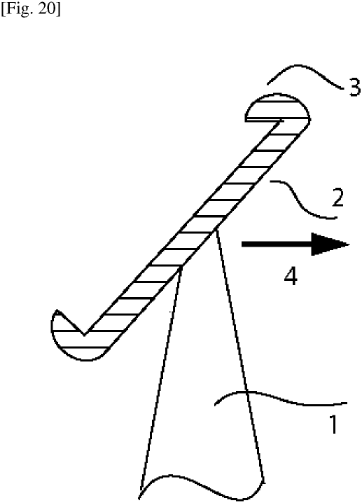

Similar to a centrifugal pump, the fast rotation of the turbine will push the gas outward toward the cones and will increase the gas pressure there. To counteract the centrifugal force the blade can be slanted forward as shown in FIG. 20. The blades have a flat surface 2 that is slanted forward relative to the forward movement 4 of the blade. When the blade rotates, the slanted surface pushes the gas inward, toward the turbine axis, and in the opposite direction to the centrifugal force that pushes the gas outward.

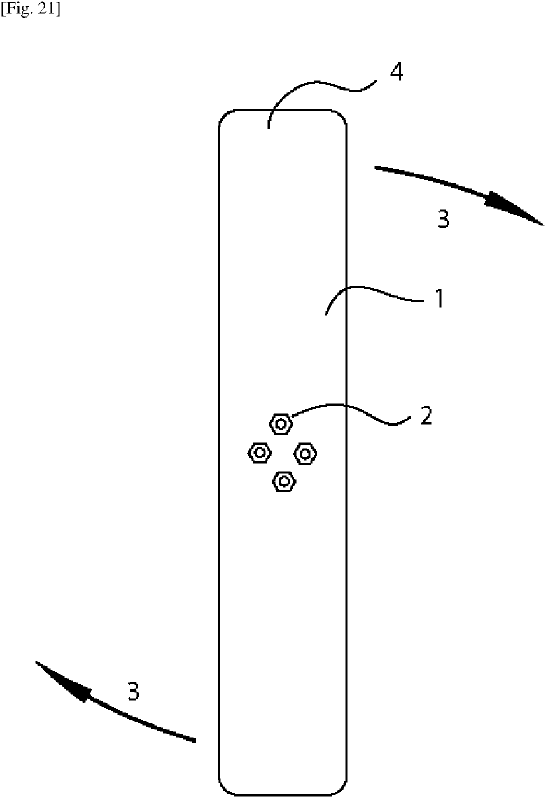

FIG. 21 shows a front view and FIG. 22 a side view of a further embodiment of the turbine, where the shape resembles that of an airplane propeller. The turbine consists of a flat metal plate 1 that is twisted in a way that a small pitch resides near the center 2 and a higher pitch at the edge 4. The edge 4 of the blade has a high pitch and the width at the edge is similar to the width at the center. Both of those features are provided so that most the shockwaves are produced at the edge and close as possible to the cones. The edge of the turbine is high enough so that it will be in a stall condition to create turbulence and avoid laminar flow pitch (the profile of the edge is denoted 5 in FIG. 22). In a standard aircraft propeller, the center has higher pitch than the tip. This way the center and edge of the propeller push the aircraft forward at the same speed. In a standard propeller the edge is also tapered to not produce turbulence that will decrease the efficiency of the propeller. Using a propeller-like shape will create shockwaves, and at the same time will push the hot gas near the cons forward toward the boilers.

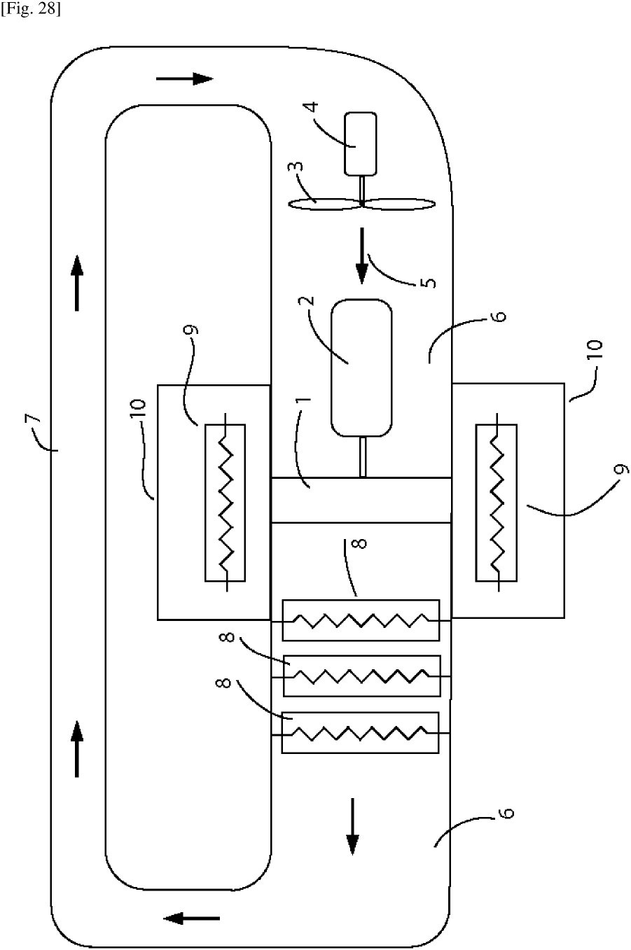

In FIG. 28 it is shown that when a turbine similar to that of FIG. 13 is installed, a nearby fan (denoted 3 in FIG. 28) is provided to blow the hot gas from the turbine and cones. The fan pushes the gas forward toward the boilers to protect the turbine and the cones from the high temperature. When a propeller-like turbine is used such a fan is not necessary.

One of the noisiest airplanes ever produced was the American fighter XF84H. This was a turboprop airplane having 5850 horsepower with Alison XT40A1 engine. Its propeller was of a small diameter - to not hit the ground - and the propeller blades were wide and of high pitch to harness the engine power. The propeller of this airplane produces strong shockwaves that translated into extreme noise. This proves that a propeller shape is very effective at producing shockwaves.

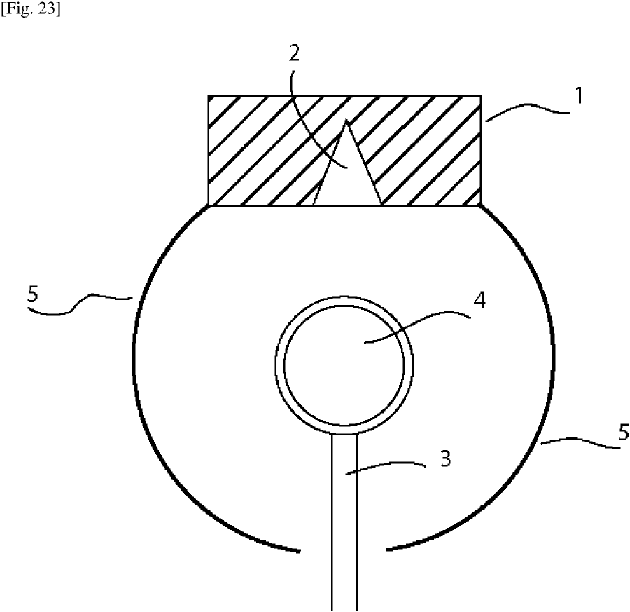

The device can use resonance to amplify and increase the amplitude of the shockwaves. In FIG. 23 there is a layout to produce resonance. The turbine 4 is enclosed in a metal walls 5 that are used to reflect the shockwaves. When the turbine rotates it produce a shockwave, this shockwave propagates outwards from the blade and hit the metal walls 5. The shockwave is then reflected from the metal walls and propagate inward. When the reflected shockwave reaches the turbine 4 it is combines with a new shockwave that is produced at that moment. The combination of the two shockwaves produce one shockwave that is stronger than each of original shockwave. This way many shockwaves can be combined into one much stronger shockwave that will hit the cones 2 to create stronger fusion event. The flat surface of the turbine is circular and will propagate the shockwave radially in all directions. The metal walls 5 are also circular and will reflect the shockwaves back to the center where the turbine 4 resides. To achieve resonance the rotation speed of the turbine is precisely controlled and synchronized so that the reflected shockwave and a new shockwave are combines together at the right moment. The turbine can use more than two blades to enable resonance at lower rotation speed of the turbine. Opening at the bottom of the metal walls enable the turbine arm 3 to pass through. Using metal walls around the turbine can be used not only for achieving resonance but also to confine the shockwaves near the cone rim. Without metal walls the shockwaves will disperse to the right and left of the turbine, and as they do not produce fusion events there, they will only waste the turbine rotation energy. The metal walls confine and reflects the shockwaves back to the cones and by that increase the efficiency of the device.

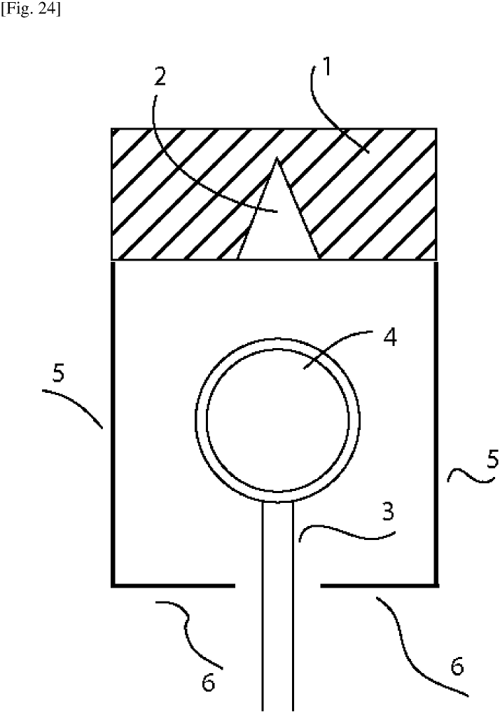

In FIG. 23 the resonance is radial between the circular metal walls and the center of their circle. In contrast in FIG. 24 the metal walls have a rectangular shape and the resonance is between the cone rim 1 and inner metal wall 6. The shockwaves bounce back and forth between those two surfaces to create a much stronger shockwave. The cones 2 can be placed less densely in the rim, so the cone rim has a flat surface to reflect the shockwaves.

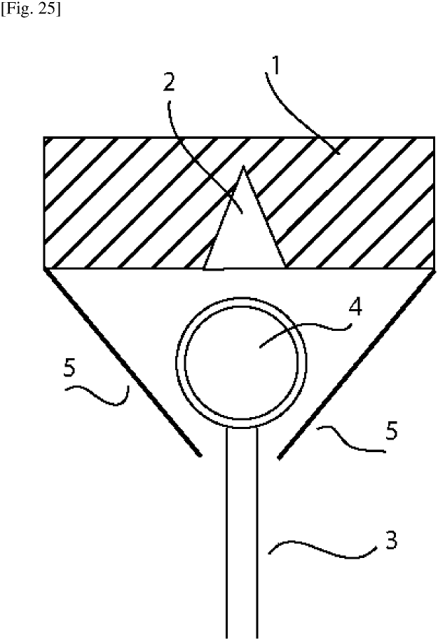

In FIG. 25 the metal walls 5 create a triangular shape with the cone rim 1. In FIGS. 23, 24 a horizontal resonance can form between the right and left side of the metal walls. This resonance is a waste of energy, as it will not create a shockwave that can enter the cones. In the arrangement of FIG. 25 there is no vertical section to the right and left metal walls so horizontal resonance is limited and its waste is avoided.

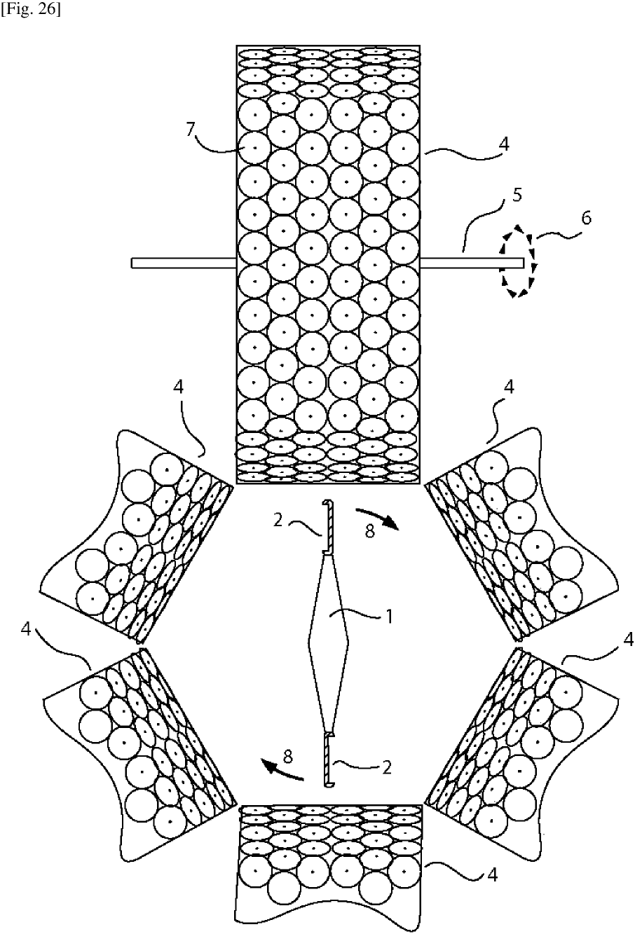

In FIG. 1 the cones are constantly bombarded with shockwaves from the turbine. This constant bombardment deteriorates the cone tip, it will cause evaporation and deform the tip shape after a short operation time. To prevent this quick destruction of the cones, the embodiment of FIG. 26 provides the cones 7 on a rotating cylinder 4. Only few of the cones 7 of the cylinder will be close enough to the turbine 2 to be hit by the shockwaves. The cones 7 on the cylinder 4 engage the shockwaves for a short period of time, the rotation of the cylinder then distant the cones from the turbine and its shockwaves. At that time, when the cones are far from the turbine, their tip can cool down. The cylinder rotates on an axis 5 and the rotation direction is shown by arrows 6. The cones in this configuration reside on the outer side of the cylinder in contrast to the embodiment of FIG. 1 where the cones reside in the inner side of the rim. There are six such cylinders 4 spaced apart by 60 degrees that create a hexagon like outline around the turbine. The turbine rotates at the center of this hexagon shown by arrows 8.

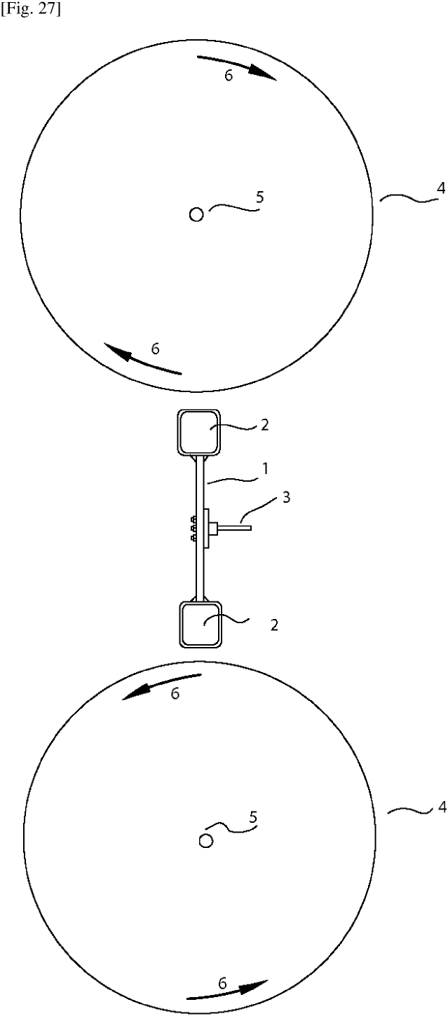

FIG. 27 shows a side view of this configuration. Only two of the six cylinders are shown for clarity - the top and bottom cylinders of FIG. 26. The cylinders 4 rotates on an axis 5 in a direction shown by arrows 6. The rotation of the cylinders will repeatedly replace the cones that face the turbine 1 and the flat surfaces 2. The cones that are near the turbine will produce fusion events while the cones far from the turbine will have a time off to cool down. The turbine axis 3 is perpendicular to the cylinder axis 5.

All the cylinders rotate in the same direction. Their rotation helps to push the hot gas forward and prevent overheating of the turbine. Relating to FIG. 26, the rotation of the cylinders is such that near the turbine they all move into the drawing page.

FIG. 28 shows a fusion powerplant that uses this fusion device to produce energy. Many of the components of this powerplant are similar to coal or nuclear fission powerplants. Coal and nuclear fission powerplants convert the heat produced by the burning of coal or fission of uranium to electricity. The heat is used to boil water in boilers that produce high pressure steam, this steam enters a steam turbine that drives an electric generator. A powerplant that uses this fusion device to produce energy will contain the same heat to electricity conversion components. The high energy neutrons and high energy alpha particles, from the fusion reaction, will produce heat. The heat will boil water in nearby boilers to produce steam, and that will be used to drive a steam turbine and an electric generator.

At the center of this powerplant is the cone rim 1, and the turbine that rotates inside it and produces shockwaves. The turbine is driven by an electric motor 2. The turbine can be rotated by other means, for instance, by a high speed steam turbine, which will use steam from the nearby boilers, or by air turbine. The electric motor 2 the cone rim 1 and the turbine reside in a sealed tank 6 filled with a mixture of tritium and deuterium gas. Near the turbine this tank will have the shape of conduit or pipe with an around profile to fit the cone rim 1. In this conduit there will also be a fan 3 driven by an electric motor 4. This fan will blow cooled gas (arrow 5 denotes the direction of the gas flow) toward the cone rim and will carry the hot gas away from the cone rim and the turbine to prevent damage from excess heat. The tank 6 will have a small diameter tube 7 that will enable to circulate the gas inside the tank. Arrows denote the gas flow direction inside the tank 6 and inside the connecting tube 7. The gas flow in the tank will carry the hot gas from the cone rim toward the boilers 8. The boilers will turn water into steam to drive a steam turbine and an electric generator.

When the gas leaves the cone rim and moves toward the boilers it is very hot, after the gas flows in the tank around the boilers 8 and pipe 7 it returns to the fan 3 and motor 4 at the beginning of the tank. At that point the gas has to be cold enough to not damage the turbine and cone rim 1. The boilers 8 reduce the gas temperature, and heat exchangers along the tube 7 reduce the gas temperature further. The motors 2 and 4 are incased and are heat insulated and water cooled to prevent damage from the hot gas.

The volume of the tank 6 has to be small as possible due to the high cost of tritium gas. If the cost of the tritium gas will reduce in the future the design of the tank can change accordingly, for instance, the diameter of the tank near the boilers 8 can be larger to accommodate more efficient and larger boilers. The diameter of the pipe 7 could also be larger to ease the gas flow.

The fusion reaction creates a flux of high energy neutrons. Those neutrons will hit a blanket 10 around the cone rim 1. The blanket is a thick layer of material, for instance, steel that will stop and absorb the neutrons and will convert their kinetic energy into heat. The blanket contains several boilers 9 that will use the blanket heat to produce steam and together with boilers 8 will turn a steam turbine and an electric generator.

The fusion reaction fuel consists of deuterium and tritium gas. Deuterium is easily produced from sea water, tritium, on the other hand, has a half-life of 12 years, and therefore cannot be found in nature. Tritium is made by bombardment of lithium with high energy neutrons in a breeding process. In a fusion reactor the tritium can be produced on site from the high energy neutrons. To produce tritium, lithium is flowing in tubes inside the said blankets 10. Small amount of the lithium atoms is hit by the high energy neutrons to produce tritium atoms, those can be collected to be used as the reactor fuel. The reactor is further provided with a system to pump fuel into the tank 6, and a system to carry the helium ash from the tank 6. There are several materials that can be used to create the blanket 10. This material has to keep its strength and properties despite the high energy neutron bombardment. There is a lot of research in this area and some of the materials that were suggested are: reduced activation ferritic steel, vanadium steel, graphite, tungsten, beryllium and lithium. Some researchers suggest that a fluid blanket is the best solution with the same fluid providing both the heat exchange and the breeding.

When the gas exits from the cone rim 1 toward the boilers 8 it has a circular motion as a result of the turbine rotation. After the gas flows through the boilers 8 and the tube 7 the gas loses its circular motion. It then reenters the cone rim without any circular motion. To further reduce the gas circular motion the fan 3 rotates in the opposite direction to the turbine 1 rotation. Also, flat fins, parallel to the gas flow direction, reside between the motor 2 and the cone rim 1 to prevent the gas circular motion near the turbine 1.

The motor 2 can be placed outside the tank 6 and be connected to the turbine by a long shaft passing through the tank walls. Placement outside the tank will protect the motor from the high temperatures and the neutron bombardment inside the tank.

A single powerplant can include many cone rims to provide large power output. One way of arranging the con rims is to place their conduit in parallel on the ground.

1. A fusion reactor comprising:
a deuterium and tritium gas tank;
a fast rotating turbine inside the said gas tank, wherein the turbine tip move faster than the gas speed of sound to produce shockwaves in the gas;
recessed members in proximity to the said turbine to concentrate the shockwaves emanating from the turbine to a focal point, the deuterium tritium gas shockwaves reach high temperature and pressure at that focal point to enable fusion reaction; and
a motor to the drive the said turbine.

2. The apparatus as claimed in claim 1, wherein the recessed members are wedge-like grooves.

3. The apparatus as claimed in claim 1, wherein the recessed members are cone-like shaped dents.

4. The apparatus as claimed in claim 3, wherein the tip of the cone resides in a bolt to be replaceable.

5. The apparatus as claimed in claim 3, wherein the cone is tilted toward the rotation direction of the turbine.

6. The apparatus as claimed in claim 3, wherein the walls of the cone are convex.

7. The apparatus as claimed in claim 3, wherein the walls of the cone are concave.

8. The apparatus as claimed in claim 1, wherein the recessed members are parabolic contoured dents, used to compress the shockwave to a focal point far from the dent wall.

9. The apparatus as claimed in claim 3, wherein the tip of the cone has a parabolic contour.

10. The apparatus as claimed in claim 3, wherein the vertex section of the cone is removed to provide a shockwave focal point outside of the cone.

11. The apparatus as claimed in claim 1, wherein the turbine tip is having a rectangular shape.

12. The apparatus as claimed in claim 1, wherein the turbine tip is having a circular shape.

13. The apparatus as claimed in claim 1, wherein the turbine tip is having a Hemispherical shape.

14. The apparatus as claimed in claim 1, wherein the turbine tip is having a spherical shape.

15. The apparatus as claimed in claim 1, wherein the turbine tip is curved backward.

16. The apparatus as claimed in claim 1, wherein the turbine tip is curved forward.

17. The apparatus as claimed in claim 1, wherein the turbine tip is tilted forward.

18. The apparatus as claimed in claim 1, wherein the turbine is having a propeller shape.

19. A fusion reactor comprising:
a deuterium and tritium gas tank;
a fast rotating turbine inside the said gas tank, wherein the turbine tip move faster than
the gas speed of sound to produce shockwaves in the gas;
recessed members in proximity to the said turbine to concentrate the shockwaves emanating from the turbine to a focal point, the deuterium tritium gas shockwave reach high temperature and pressure at that focal point to enable fusion reaction;
walls around the turbine tip to enable resonance of the shockwaves;
and a motor to the drive the said turbine.

20. The apparatus as claimed in claim 19, wherein the resonance walls are of circular shape.

21. The apparatus as claimed in claim 19, wherein the resonance walls are of rectangular shape.

22. The apparatus as claimed in claim 19, wherein the resonance walls are of triangular shape.

23. The apparatus as claimed in claim 3, wherein the cones are located on rotating rims.
